(19) United States
(12) Patent Application Publication
(10) Pub. No.: US 2011/0304764 A1
(43) Pub. Date: Dec. 15, 2011

(54) LENS ELEMENT, IMAGING LENS, AND IMAGING MODULE

(76) Inventors: Norimichi Shigemitsu, Osaka-shi (JP); Hiroyuki Hanato, Osaka (JP)

(21) Appl. No.: 13/159,755

(22) Filed: Jun. 14, 2011

(30) Foreign Application Priority Data
Jun. 15, 2010 (JP) 2010-136409

(51) Int. Cl. H04N 5/232; G02B 9/00; G02B 9/14

(52) U.S. Cl. 348/345; 359/785; 359/642; 348/E05.045

(57) ABSTRACT

In order to provide (i) a simple-structured imaging module that is arranged to have resolution good enough to satisfy required specifications both in photographing a near-by object and in photographing a distant object, (ii) a lens element constituting the imaging module, and (iii) an imaging lens constituting the imaging module, at least one lens surface of a first lens is constituted by a plurality of regions having different refractive power so that a range of an allowable object distance is increased.

This Nonprovisional application claims priority under 35 U.S.C. §119(a) on Patent Application No. 2010-136409 filed in Japan on Jun. 15, 2010, the entire contents of which are hereby incorporated by reference.

### TECHNICAL FIELD

The present invention relates to (i) an imaging module that is arranged to have resolution good enough to satisfy required specifications in both photographing a near-by object and photographing a distant object, (ii) a lens element constituting the imaging module, and (ii) an imaging lens constituting the imaging module.

### BACKGROUND ART

Patent Literature 1 discloses an automatic focusing device in which a focal position of a lens is changed by applying an electric field or a magnetic field to the lens so as to change a refractive index.

Patent Literature 2 discloses an automatic focusing method for an optical device. According to the automatic focusing method disclosed in Patent Literature 2, an electric signal obtained in accordance with a distance to a subject is supplied to a piezoelectric element. This changes a thickness of the piezoelectric element. Thus, a location of a lens is controlled.

Patent Literatures 3 and 4 each disclose a lens adjusting device including an adjusting mechanism for moving a location of a lens by rotation of an adjustment lever.

Patent Literature 5 discloses an imaging device which injects gas between a light-transmitting plate and a lens so as to move a location of the lens.

According to the techniques disclosed in Patent Literatures 1 through 5, a location or a focal position of a lens (lens element) is changed in accordance with an object distance so that an optical system has resolution good enough to satisfy required specifications in both photographing a near-by object and photographing a distant abject.

### CITATION LIST

Patent Literature 1

Japanese Patent Application Publication, Tokukaisho, No. 59-022009 A (Publication Date: Feb. 4, 1984)

Patent Literature 2

Japanese Patent Application Publication, Tokukaisho, No. 61-057918 A (Publication Date: Mar. 25, 1986)

Patent Literature 3

Japanese Patent Application Publication, Tokukaihei, No. 10-104491 A (Publication Date: Apr. 24, 1998)

Patent Literature 4

Japanese Patent Application Publication, Tokukaihei, No. 10-170809 A (Publication Date: Jun. 26, 1998)

Patent Literature 5

Japanese Patent Application Publication, Tokukai, No. 2003-029115 A (Publication Date: Jan. 29, 2003)

### SUMMARY OF INVENTION

### Technical Problem

Each of the techniques disclosed in Patent Literatures 1 through 5 requires a mechanism for changing a location or a focal position of a lens in accordance with an object distance. This undesirably complicates a structure of an optical system.

The present invention was attained in view of the above problems, and an object of the present invention is to provide (i) a simple-structured imaging module that is arranged to have resolution good enough to satisfy required specifications in both photographing a near-by object and photographing a distant object, (ii) a lens element constituting the imaging module, and (iii) an imaging lens constituting the imaging module.

### Solution to Problem

In order to attain the above object, a lens element of the present invention has at least one lens surface that is constituted by a plurality of regions having different refractive power so that a range of an allowable object distance is increased.

The term “allowable object distance” refers to a distance, between an optical system and an object, within which substantially all parts of an image of the object formed by the optical system have desired resolution or higher. In other words, this term refers to a distance, between an optical system and an object, within which the optical system can be focused on substantially all parts of the object. The optical system may be a lens element, an imaging lens, an imaging module or the like. The term “lens element” refers to a single lens. This term is used to clearly distinguish a single lens from a member (i.e., an imaging lens) including a plurality of lenses.

According to the arrangement, a lens surface is constituted by two or more regions having different refractive power. Accordingly, a location at which light passing through one region is focused is deviated from a location at which light passing through another region is focused in a direction in which an optical axis of the lens element extends. This makes it possible to produce an optical system which allows substantially all parts of an object to be imaged at desired resolution or higher over a larger object distance. In other words, it is possible to produce an optical system which can be focused on substantially all parts of an object over a larger object distance.

Consequently, according to the arrangement, it is possible to produce, with the use of the lens element of the present invention, a simple-structured imaging module that is arranged to have resolution good enough to satisfy required specifications both in photographing a near-by object and in photographing a distant object.

An imaging lens of the present invention includes an aperture stop; a first lens having positive refractive power; and a second lens, the aperture stop, the first lens, and the second lens being provided in this order from an object side to an image surface side, the first lens being the lens element of the present invention, and a surface of the first lens which surface faces the object side being the at least one lens surface of the lens element.

According to the arrangement, it is possible to produce an imaging lens that is constituted by at least two lenses (lens elements) and that produces a similar effect to the lens element of the present invention.

An imaging lens of the present invention includes the imaging lens of the present invention, and does not include a mechanism for adjusting a focal position of the imaging lens.

According to the arrangement, it is possible to produce an imaging module that produces a similar effect to the lens element of the present invention.

In a case where an imaging module includes an imaging lens constituted by three lenses (lens elements), it is possible to produce a compact and inexpensive camera module that has a simple structure and has good resolution. Especially a camera module for use in a mobile apparatus often includes an imaging lens including three lenses, i.e., an imaging lens including, from an object side to an image surface side, an aperture stop, a first lens having positive refractive power, a second lens (meniscus lens) having negative refractive power, and a third lens whose surface facing an image surface side has a concave central part and a convex peripheral part surrounding the concave central part since such an imaging lens is compact and can achieve high resolution. Accordingly, according to the imaging module of the present invention, it is possible to produce an inexpensive camera module that has a simple structure and that does not include a focusing mechanism for adjusting a focal position of an imaging lens.

Further, also in a case where an imaging module includes an imaging lens constituted by two lenses (lens elements), it is possible to produce a compact and inexpensive camera module that has a simple structure and has good resolution. Especially a camera module for use in a mobile apparatus often includes an imaging lens including two lenses, i.e., an imaging lens including, from an object side to an image surface side, an aperture stop, a first lens having positive refractive power and a second lens having negative refractive power, since such an imaging lens is compact and can achieve high resolution. Accordingly, according to the imaging module of the present invention, it is possible to produce an inexpensive camera module that has a simple structure and that does not include a focusing mechanism for adjusting a focal position of an imaging lens.

### Advantageous Effects of Invention

As described above, a lens element of the present invention has at least one lens surface that is constituted by a plurality of regions having different refractive power so that a range of an allowable object distance is increased.

Accordingly, the present invention produces an effect that it is possible to produce a simple-structured imaging module that is arranged to have resolution good enough to satisfy required resolution both in photographing of a near-by object and in photographing of a distant object.

### BRIEF DESCRIPTION OF DRAWINGS

FIG. 1 is a graph showing a shape of at least one lens surface.

FIG. 2 is a cross-sectional view illustrating a configuration of an imaging lens of an embodiment of the present invention.

FIG. 3 is a cross-sectional view showing that at least one lens surface is constituted by a plurality of regions having different refractive power.

FIG. 4 is a graph showing defocus MTFs of the imaging lens shown in FIG. 2.

FIG. 5 is a graph showing MTF-image height properties of the imaging lens shown in FIG. 2.

(a) of FIG. 6 is a graph showing an astigmatism property of the imaging lens shown in FIG. 2, and (b) of FIG. 6 is a graph showing a distortion property of the imaging lens shown in FIG. 2.

FIG. 7 is a table showing design data of the imaging lens shown in FIG. 2.

FIG. 8 is a cross-sectional view illustrating a configuration of an imaging lens to be compared with the imaging lens shown in FIG. 2.

FIG. 9 is a graph showing defocus MTFs of the imaging lens shown in FIG. 8.

FIG. 10 is a graph showing MTF-image height properties of the imaging lens shown in FIG. 8.

(a) of FIG. 11 is a graph showing an astigmatism property of the imaging lens shown in FIG. 8, and (b) of FIG. 11 is a graph showing a distortion property of the imaging lens shown in FIG. 8.

FIG. 12 is a table showing design data of the imaging lens shown in FIG. 8.

FIG. 13 is a table for comparing design specification of the imaging lens shown in FIG. 2 and design specification of the imaging lens shown in FIG. 8.

FIG. 14 is a graph comparing an MTF-object distance property of the imaging lens shown in FIG. 2 and an MTF-object distance property of the imaging lens shown in FIG. 8, in which graph the MTF-object distance properties at the image height h0 are shown.

FIG. 15 is a graph comparing an MTF-object distance property of the imaging lens shown in FIG. 2 and an MTF-object distance property of the imaging lens shown in FIG. 8, in which graph the MTF-object distance properties in a tangential image surface at the image height h0.6 are shown.

FIG. 16 is a graph comparing a defocus MTF of the imaging lens shown in FIG. 2 and a defocus MTF of the imaging lens shown in FIG. 8 that are respectively obtained in a case where the imaging lens shown in FIG. 2 and the imaging lens shown in FIG. 8 are combined with an arrangement in which depth of field is expanded.

FIG. 17 is a graph comparing an MTF-object distance property of the imaging lens shown in FIG. 2 and an MTF-object distance property of the imaging lens shown in FIG. 8 that are respectively obtained in a case where the imaging lens shown in FIG. 2 and the imaging lens shown in FIG. 8 are combined with an arrangement for obtaining an image having resolution higher than predetermined standard resolution.

### DESCRIPTION OF EMBODIMENTS

### Embodiment

(Configuration of Imaging Lens 1)

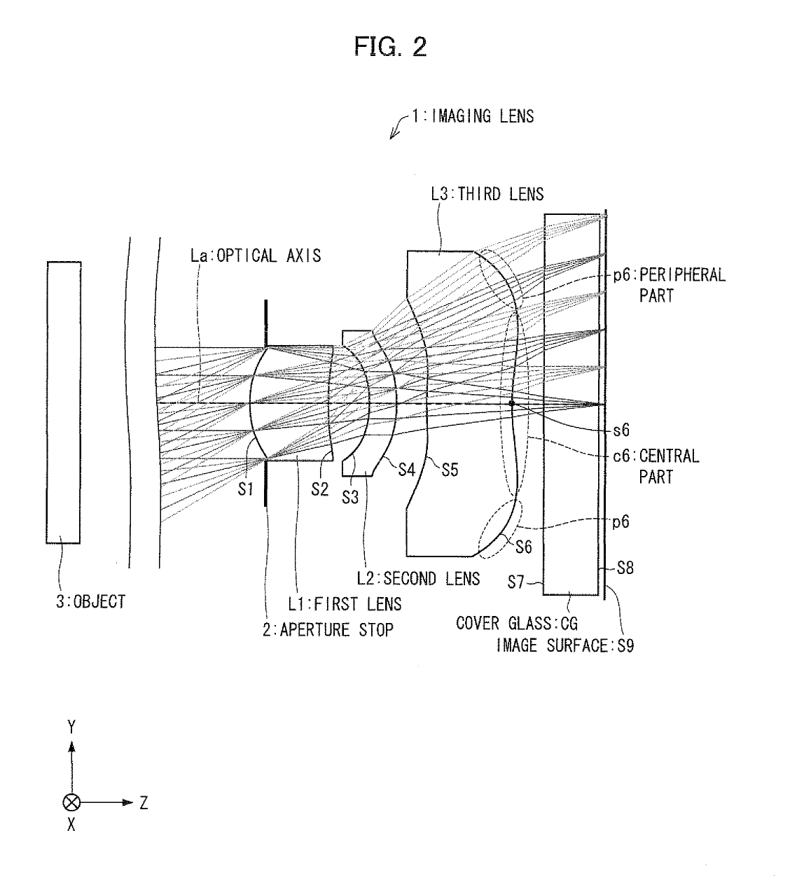

FIG. 2 is a cross-sectional view illustrating a configuration of an imaging lens 1 of an embodiment of the present invention.

FIG. 2 shows a cross-section of the imaging lens 1 that is defined by a Y-direction (top-to-bottom direction of the paper) and a Z-direction (left-to-right direction of the paper). The Z-direction refers to a direction pointing from an object 3 towards an image surface S9 and a direction pointing from the image surface S9 towards the object 3. An optical axis La of the imaging lens 1 extends in the Z-direction. A normal to the optical axis La of the imaging lens 1 extends along a plane defined by an X-direction (direction vertical to the paper) and the Y-direction.

The imaging lens 1 includes an aperture stop 2, a first lens (lens element) L1 having positive refractive power (power), a second lens L2 having negative refractive power, a third lens L3 having positive refractive power, and cover glass CG in this order from the object 3 side to the image surface S9 side.

Specifically, the aperture stop 2 is provided so as to surround a surface (at least one lens surface) S1 of the first lens L1 which surface S1 faces the object 3. The aperture stop 2 serves to limit a diameter of a bundle of rays on an axis of light incident on the imaging lens 1 so that the incident light can appropriately pass through the first lens L1, the second lens L2, and the third lens L3.

The object 3 is an object whose image is to be formed by the imaging lens 1. In other words, the object 3 is a subject of imaging of the imaging lens 1. In FIG. 2, for convenience of illustration, the object 3 and the imaging lens 1 are provided in close proximity to each other, but a distance between the object 3 and the imaging lens 1 is not limited, and can be, for example, an infinite distance in maximum.

The first lens L1 is arranged such that the surface (object-side surface) S1 which faces the object 3 is convex and a surface (image-side surface) S2 which faces the image surface S9 is concave. Such an arrangement of the first lens L1 increases a ratio of an entire length of the first lens L1 to an entire length of the imaging lens 1, thereby making it possible to increase a ratio of a focal distance of the whole imaging lens 1 to the entire length of the imaging lens 1. This allows a reduction in size and height of the imaging lens 1. The first lens L1 has an Abbe number of as large as about 56, so that dispersion of incident light is suppressed. The shape of the first lens L1, especially the shape of the surface S1 is described later in detail.

The Abbe number is a constant number for an optical medium, and is a ratio of refractivity to dispersion of light. That is, the Abbe number indicates a degree of refraction of light having different wavelengths in different directions. A medium having a larger Abbe number causes less dispersion related to a degree of refraction of light having different wavelengths.

The term “concave” or “concave surface” refers to a hollow part of a lens, that is, a part which is curved inward. The term “convex” or “convex surface” refers to a spherical part of a lens which bulges outwards.

Precisely, the aperture stop 2 is provided so that the convex surface S1 of the first lens L1 protrudes towards the object 3 beyond the aperture stop 2, but another arrangement is also possible in which the surface S1 does not protrude towards the object 3 beyond the aperture stop 2. It is only necessary that a representative location of the aperture stop 2 be located closer to the object 3 than a representative location of the first lens L1.

The second lens L2 is a known meniscus lens in which a surface S3 facing the object 3 is concave and a surface S4 facing the image surface S9 is convex. Since the second lens L2 is a meniscus lens whose concave surface faces the object 3, it is possible to reduce a Petzval sum (on-axis property of curvature of an image of a plane object which is produced by an optical system) while maintaining refractive power of the second lens L2. This allows a reduction in astigmatism, field curvature, and coma aberration. The second lens L2 has an Abbe number of as small as about 26, so that dispersion of incident light is increased. The configuration in which the first lens L1 having a large Abbe number and the second lens L2 having a small Abbe number are combined is effective in correcting chromatic aberration.

The third lens L3 is arranged such that a surface S5 facing the object 3 is concave and a surface S6 facing the image surface S9 has (i) a concave central part c6 which corresponds to a center s6 and a nearby-area and (ii) a convex peripheral part p6 which surrounds the central part c6. That is, the surface S6 of the third lens L3 can be interpreted as an inflection surface having an inflection point at which curvature changes from concave (the central part c6) to convex (the peripheral part p6) or vice versa. The “inflection point” refers to a point on an aspheric surface which point is present on a curve of a cross-sectional shape of the lens within an effective radius of the lens and at which point a plane tangent to a vertex of the aspheric surface is a plane perpendicular to the optical axis.

The imaging lens 1 including the third lens L3 having the inflection point on the surface S6 allows light beams passing through the central part c6 to be focused on a point nearer to the object 3 in the Z-direction and allows light beams passing through the peripheral part p6 to be focused on a point nearer to the image surface S9 in the Z-direction. Accordingly, the imaging lens 1 can correct various kinds of aberration such as field curvature in accordance with a specific shape (concave shape) of the central part c6 and a specific shape (convex shape) of the peripheral part p6.

Each of the second lens L2 and the third lens L3 is a lens in which both of a surface facing the object 3 and a surface facing the image surface S9 are aspherical surfaces. The second lens L2 in which both surfaces are aspherical can greatly correct especially astigmatism and field curvature. The third lens L3 in which both surfaces are aspherical can greatly correct especially astigmatism, field curvature, and distortion. Further, the third lens L3 in which both surfaces are aspherical can improve telecentric properties in the imaging lens 1. Accordingly, the imaging lens 1 can easily expand a depth of field by reducing NA (numerical aperture).

The imaging lens 1 configured as above (see FIG. 2) which includes the first lens L1, the second lens L2, and the third lens L3 can expand a depth of field and can reduce field curvature.

The cover glass CG is provided between the third lens L3 and the image surface S9. The cover glass CO covers the image surface S9, so that the image surface S9 is protected from physical damage etc. The cover glass CG has a surface S7 facing the object 3 and a surface S8 facing the image surface S9.

The image surface S9 is a surface which is vertical to the optical axis La of the imaging lens 1 and on which an image is formed. A real image can be observed on a screen (not shown) placed on the image surface S9.

The imaging lens 1 preferably has an f-number of less than 3.0. This makes it possible to obtain a bright image. The f-number of the imaging lens 1 is expressed as an equivalent focal length of the imaging lens 1 divided by an entrance pupil diameter of the imaging lens 1.

The imaging lens 1 includes three lenses, i.e., the first lens L1, the second lens L2, and the third lens L3, but the number of lenses of an imaging lens of the present invention is not limited to three, and may be, for example, two. In order to change the imaging lens 1 to an imaging lens provided with two lenses, it is only necessary that the third lens L3 be eliminated and the second lens L2 be shaped such that the surface facing the image surface S9 has a concave central part and a convex peripheral part surrounding the central part (i.e., the second lens L2 has a shape similar to that of the third lens L3 shown in FIG. 2).

(Configuration of First Lens)

The following description deals with the shape of the first lens L1, especially the shape of the surface S1.

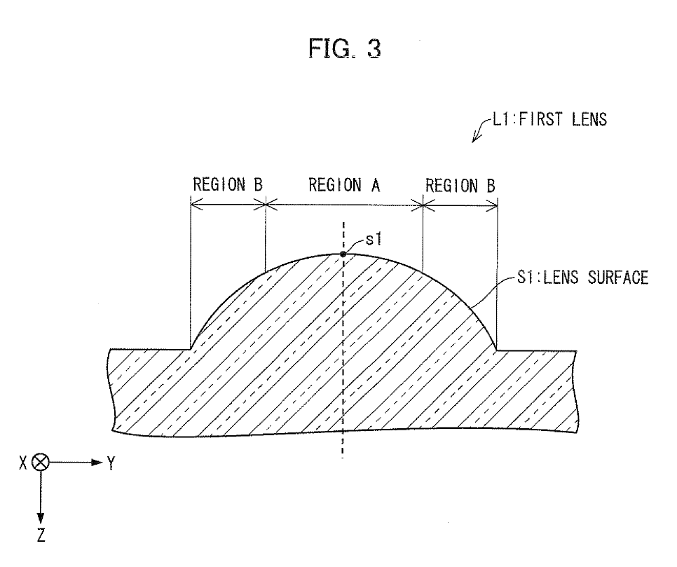

FIG. 3 is a cross-sectional view showing that the surface S1 which is a lens surface of the first lens L1 is constituted by a plurality of regions A and B. In FIG. 3, for convenience of illustration, the first lens L1 is illustrated as a conventional general spherical lens since only the explanation concerning the regions of the present invention is made with reference FIG. 3.

In FIG. 2, only a part of the surface S1 that corresponds to an effective aperture is illustrated, but in FIG. 3, an edge portion (lens edge portion) of the first lens L1 that is provided around the effective aperture is also illustrated. Not only the first lens L1, but also the other lenses constituting the imaging lens 1 are generally provided with an edge around an effective aperture. Further, for convenience of illustration, in FIG. 3, a the surface S2 side portion of the first lens L1 and the aperture stop 2 (see FIG. 2) are not illustrated.

In FIG. 3, the surface S1 of the first lens L1 is divided into the region A that corresponds to a center s1 and a near-by area and the region B that surrounds the region A.

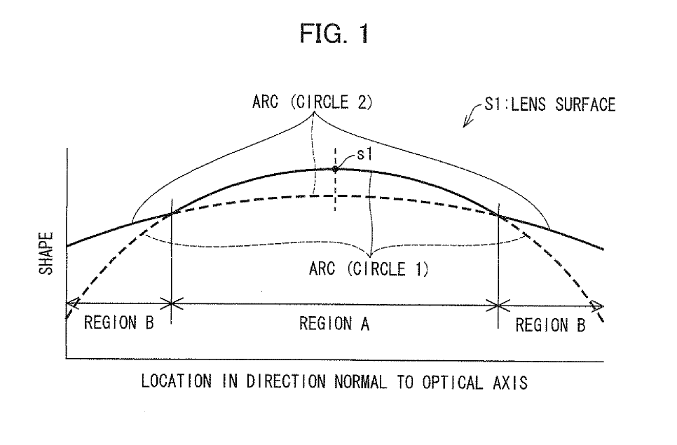

FIG. 1 is a graph showing a specific shape of the surface S1. In this graph, the horizontal axis represents a location of the surface S1 in a direction normal to the optical axis La, and the vertical axis represents the shape of the surface S1 (in other words, location of the surface S i in a direction in which the optical axis La extends).

In the graph shown in FIG. 1, the shape of the surface S1 is indicated by the solid line. As indicated by the solid line in the graph shown in FIG. 1, the regions A and B of the surface S1 are different in radius of curvature. More specifically, in FIG. 1, the region A corresponds to an arc of a circle 1, whereas the region B corresponds to an arc of a circle 2 which has a larger radius than the circle 1. Accordingly, in the surface S1 of the first lens L1, the radius of curvature of the region B is larger than that of the region A.

As described above, the surface S1 of the first lens L1 is arranged such that the plurality of regions A and B have different radii of curvature.

Since the regions A and B are different in radius of curvature, the regions A and B are different in refractive power. That is, it can be interpreted that the surface S1 which is a lens surface of the first lens L1 is constituted by the plurality of regions A and B that are different in refractive power.

The refractive power of the regions A and B is determined so that predetermined desired resolution can be obtained. Since the regions A and B are different in refractive power, the regions A and B are different in location of a best image surface (object image formation location) in the Z-direction (see FIG. 2). The regions A and B are arranged to have different refractive power such that predetermined desired resolution can be obtained on a determined location of the image surface S9 (see FIG. 2). That is, the refractive power of the regions A and B are preferably determined so that predetermined resolution can be obtained on a determined location of the image surface S9. Regardless of whether the refractive power of the regions A and B is determined by causing the radius of curvature of the region A to be different from that of the region B or by dividing a lens surface into the regions A and B, the refractive power of the regions A and B is determined so that predetermined desired resolution can be obtained.

However, it is difficult to specify preferable values of the refractive power and radius of curvature of the regions A and B since such values vary depending on the desired resolution in a corresponding optical system.

Further, it is normally difficult to determine the regions A and B that are different regions of a lens surface, but in this case, the regions A and B can be determined based on the following recommended condition. Specifically, in a case where the surface S1 of the imaging lens 1 is a substantially spherical lens surface constituted, by N (N is a natural number of 2 or more) regions, each of the N regions is a circular region or a doughnut-like region surrounding the circular region which occupies about 1/N of the effective aperture of the surface S1 when viewed from the object 3 side (top surface side of the surface S1). Thus, it is possible to easily determine the N regions.

The imaging lens 1 is arranged such that only the surface S1 of the first lens L1 is constituted by a plurality of regions (the regions A and B) that are different in refractive power. However, the imaging lens 1 is not limited to this arrangement. Another arrangement is also possible in which any one or more of the surfaces S1 through S6 is constituted by a plurality of regions having different refractive power. Also in a case where the number of lenses provided in an imaging lens is not three, any one or more of lens surfaces constituting the imaging lens may be constituted by a plurality of regions having different refractive power. The first lens L1 is arranged such that the surface S1 is constituted by two regions (the regions A and B) having different refractive power. However, the first lens L1 is not limited to this arrangement. Another arrangement is also possible in which the surface S1 is constituted by three or more regions having different refractive power. The same is true for an arrangement in which a lens surface that is not the surface S1 of the first lens L1 is constituted by a plurality of regions having different refractive power. In a case where these arrangements are employed, the imaging lens forms an image of an object at two places in the Z-direction (see FIG. 2). This makes it possible to obtain a more effective imaging lens that is deeper in depth of field. For example, an imaging lens having these arrangements is effective in a case where a lens surface in which light beams pass through different lens regions depending on the image height is constituted by a plurality of regions having different refractive power. These arrangements are suitably applied since refractive power which varies depending on the image height is required in the lens surface.

Further, the arrangement in which a plurality of regions of a lens surface have different refractive power is not limited to an arrangement in which these regions have different radii of curvature. Another arrangement is also effective in which a lens surface corresponding to at least one region is a so-called diffracting surface for diffracting incident light. Not only by changing radius of curvature of a lens surface, but also by changing the lens surface to a diffracting surface, it is possible to easily give refractive power to the lens surface.

(Function of First Lens L1 and Imaging Lens 1)

Since the lens surface S1 of the first lens L1 is constituted by the plurality of regions A and B that are different in refractive power, a range of an allowable object distance is large.

The term “allowable object distance” refers to a distance, between an optical system including the first lens L1 and the object 3, within which substantially all parts of an image of the object 3 formed by the optical system have desired resolution or higher. In other words, this term refers to a distance within which the optical system can be focused on substantially all parts of the object 3. The optical system may be the first lens L1 itself, the imaging lens 1, or an imaging module described later.

Since the surface S1 is constituted by the regions A and B, a location at which light passing through the region A is focused is deviated from a location at which light passing through the region B is focused in the Z-direction. This makes it possible to produce an optical system which allows substantially all parts of the object 3 to be imaged at desired resolution or higher over a larger object distance. In other words, it is possible to produce an optical system which can be focused on substantially all parts of the object 3 over a larger object distance.

Accordingly, the first lens L1 can be used to constitute a simple-structured imaging module that is arranged to have resolution good enough to satisfy required specifications in both photographing a near-by object and photographing a distant object.

The regions A and B of the surface S1 may be different in radius of curvature or the region A and/or B may be a diffracting surface for diffracting incident light.

This makes it possible to easily produce the first lens L1 having the surface S1 that is constituted by the plurality of regions A and B having different refractive power.

The imaging lens 1 includes the aperture stop 2, the first lens L1 having positive refractive power, and the second lens L2 in this order from the object 3 side to the image surface S9 side. Further, the imaging lens 1 may be arranged to further include the third lens L3 disposed nearer to the image surface S9 than the second lens L2, the second lens L2 having negative refractive power, the third lens L3 having positive refractive power, and the surface S6 of the third lens L3 which faces the image surface S9 having the concave central part c6 and the convex peripheral part p6. Further, the imaging lens 1 may be arranged such that the surface S4 of the second lens L2 which surface S4 faces the image surface S9 has a concave central part and a convex peripheral part surrounding the central part.

This makes it possible to produce the imaging lens 1 constituted by at least two lenses that produces a similar effect to the first lens L1.

Further, in a case where the f-number of the imaging lens 1 is less than 3.0, it is possible to produce, with the use of the imaging lens 1 which can obtain a bright image, an optical system in which a range of an allowable object distance is large. Note that the range of an allowable object distance can be made larger by increasing the f-number, but an increase in f-number makes an image dark. The imaging lens 1 having the f-number of less than 3.0 allows an optical system which can obtain a bright image to obtain a large range of an allowable object distance.

(Optical Properties and Design Data of Imaging Lens 1)

The following description deals with optical properties and design data of the imaging lens 1.

Note that the optical properties and design data were measured in consideration of the following conditions:
The object distance is set to 1700 mm (equal to a hyperfocal distance of the imaging lens 1).
White light weighted as follows is used as a simulation light source (not shown) (mixing rate of wavelengths constituting the white light is adjusted as follows):

404.66 nm=0.13

435.84 nm=0.49

486.1327 nm=1.57

546.07 nm=3.12

587.5618 nm=3.18

656.2725 nm=1.51
The imaging lens 1 is focused on the vicinity of a best image surface obtained in a case where the object distance is the hyperfocal distance (approximately 1700 mm).
A sensor (solid-state image sensing device) having the pixel number of 2 mega-pixels (2M-class sensor) and a size of ⅕-inch is disposed on the image surface S9.

(MTF Properties of Imaging Lens 1)

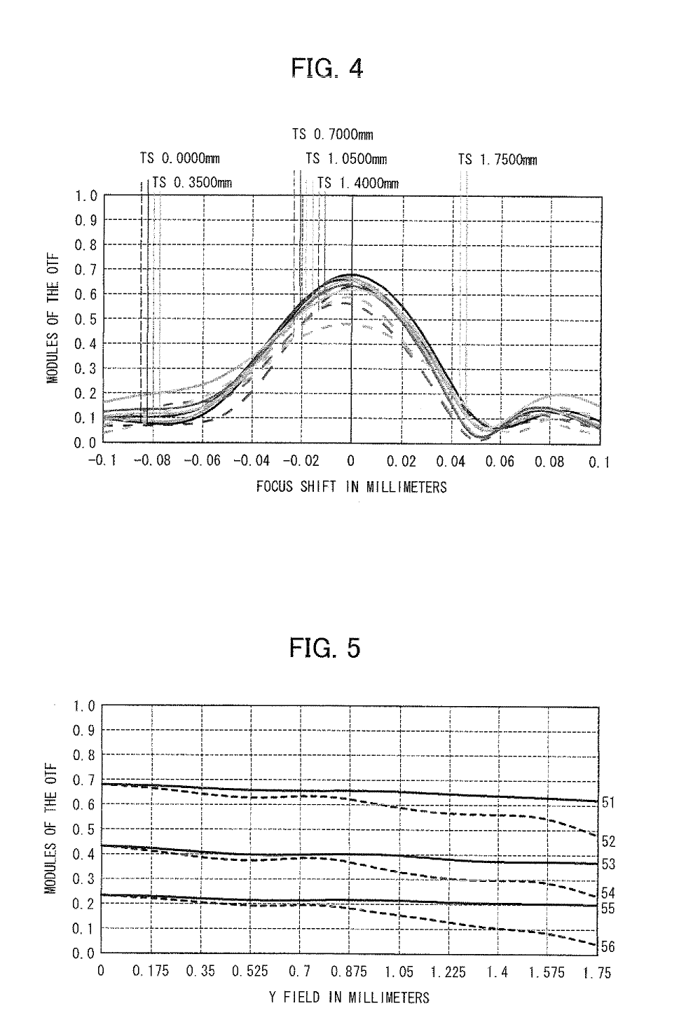

FIG. 4 is a graph showing defocus MTFs in the imaging lens 1, i.e., relationships in the imaging lens 1 between an MTF (unit: none) represented by the vertical axis and a focus shift position (unit: mm) represented by the horizontal axis.

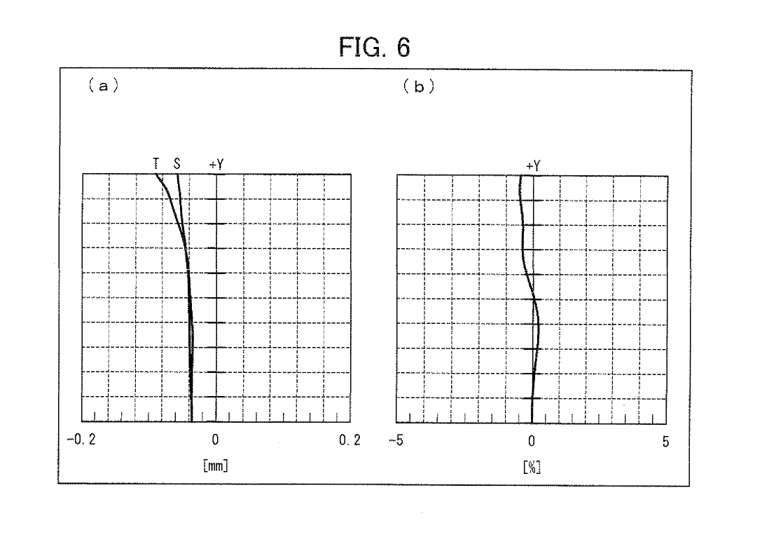

FIG. 5 is a graph showing relationships in the imaging lens 1 between an MTF represented by the vertical axis and an image height (unit: mm) represented by the horizontal axis.

Note that the MTF (Modulation Transfer Function) is an indicator indicating how contrast of an image formed on an image surface changes as the image surface is moved in an optical axis direction. As the MTF becomes larger, it can be determined that resolution of an image formed on an image surface becomes higher.

The image height shown in the present embodiment is expressed as an absolute value of a height from a center of an image of the object 3 formed by the imaging lens 1 or as a ratio of the length from the center of the image to the maximum image height. In a case where the image height is expressed as a ratio of the length from the center of the image to the maximum image height, the following correlation is established between the ratio and the absolute value:

0 mm=image height h0 (center of the image)

0.175 mm=image height h0.1 (height, from the center of the image, corresponding to 10% of the maximum image height)

0.35 mm=image height h0.2 (height, from the center of the image, corresponding to 20% of the maximum image height)

0.7 mm=image height h0.4 (height, from the center of the image, corresponding to 40% of the maximum image height)

1.05 mm=image height h0.6 (height, from the center of the image, corresponding to 60% of the maximum image height)

1.4 mm=image height h0.8 (height, from the center of the image, corresponding to 80% of the maximum image height)

1.75 mm=image height h1.0 (the maximum image height)

FIG. 4 shows examples of properties in a tangential image surface (T) and a sagittal image surface (S) at the image height h0, image height h0.2, image height h0.4, image height h0.6, image height h0.8, and image height h1.0 at a spatial frequency of “Nyquist frequency/4”.

FIG. 5 shows examples of properties in the tangential image surface and the sagittal image surface at the image heights h0 to h1.0 at spatial frequencies of “Nyquist frequency/4”, “Nyquist frequency/2”, and “Nyquist frequency”.

Note that the Nyquist frequency corresponds to Nyquist frequency of the sensor (solid-state image sensing device) disposed on the image surface S9, and is a value of a resolvable spatial frequency calculated from a pixel pitch of the sensor. Specifically, the Nyquist frequency Nyq. (unit: 1 p/mm) of the sensor is obtained by the following equation:

Nyq.=1/(pixel pitch of the sensor)/2

As shown in FIG. 4, the imaging lens 1 has a high MTF property of not less than 0.2 on the image surface S9 (see FIG. 2), which corresponds to the focus shift position of 0 mm, at any of the image heights h0 to h1.0 in both of the tangential image surface and the sagittal image surface. This shows that an image of the object 3 formed by the imaging lens 1 has good resolution from the center to periphery thereof.

In FIG. 5, the graph 51 shows an MTF in the sagittal image surface at the spatial frequency corresponding to the “Nyquist frequency/4”, and the graph 52 shows an MTF in the tangential image surface at the same spatial frequency. In FIG. 5, the graph 53 shows an MTF in the sagittal image surface at the spatial frequency corresponding to the “Nyquist frequency/2”, and the graph 54 shows an MTF in the tangential image surface at the same spatial frequency. In FIG. 5, the graph 55 shows an MTF in the sagittal image surface at the spatial frequency corresponding to the “Nyquist frequency”, and the graph 56 shows an MTF in the tangential image surface at the same spatial frequency.

As shown in FIG. 5, in the graph 56, the imaging lens 1 has an MTF of less than 0.2 at the image height h0.3 (0.525 mm) and higher, but in the graphs 51 to 55, the imaging lens 1 has a high MTF property of not less than 0.2 at any of the image heights h0 to h1.0.

(Aberration Property of Imaging Lens 1)

(a) of FIG. 6 is a graph showing relationship, in the imaging lens 1, between the image height (unit: ratio, i.e., image heights h0 to h1.0) represented by the vertical axis and astigmatism (unit: mm) represented by the horizontal axis.

(b) of FIG. 6 is a graph showing relationship, in the imaging lens 1, between the image height (unit: ratio, i.e., image heights h0 to h1.0) represented by the vertical axis and distortion (unit: %) represented by the horizontal axis.

(a) and (b) of FIG. 6 show that both of the astigmatism and the distortion are corrected well in the imaging lens 1.

(Design Data of Imaging Lens 1)

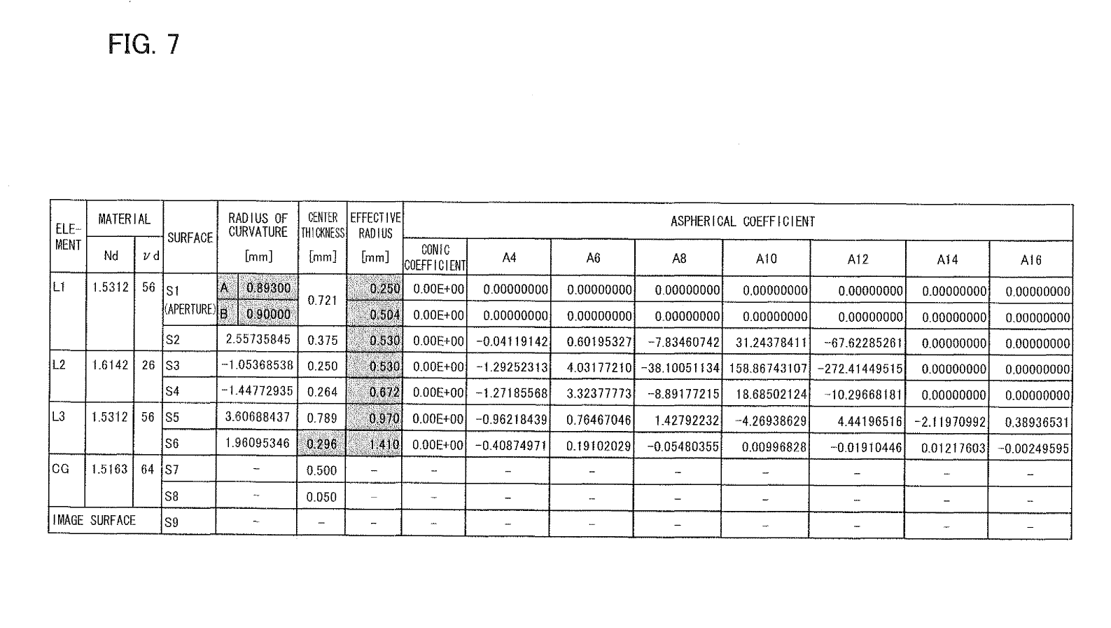

FIG. 7 is a table showing design data of the imaging lens 1. The items shown in FIG. 7 are defined as follows:

“ELEMENT”: Constituent members of the imaging lens. Specifically, “L1” represents the first lens L1, “L2” represents the second lens L2, “L3” represents the third lens L3, “CG” represents the cover glass CG, and “IMAGE SURFACE” represents the image surface S9.

“Nd (MATERIAL)”: Refractive indices of the constituent members of the imaging lens at the d-ray (wavelength: 587.6 nm).

“vd (MATERIAL)”: Abbe number of the constituent members of the imaging lens at the d-ray.

“SURFACE”: Surfaces of the constituent members of the imaging lens. Specifically, “S1” through “S9” represent the surfaces S1 through S8 and the image surface S9, respectively. Note that “S1” is a surface surrounded by the aperture stop 2.

“RADIUS OF CURVATURE”: Radii of curvature (unit: mm) of the surfaces S1 through S6. As to the surface S1, “A” shows radius of curvature of the region A (see FIG. 1), and “B” shows radius of curvature of the region B (see FIG. 1).

“CENTER THICKNESS”: Distance (unit: mm) from a first center of one of two surfaces to a second center of the other one of the two surfaces which first and second centers are adjacent in a direction in which the optical axis La extends (the Z-direction in FIG. 2), the second center being nearer to the image surface S9 than the first center.

“EFFECTIVE RADIUS”: Effective radii (unit: mm) of the surfaces S1 through S6, i.e., a radius of a circular area in which a range of a luminous flux can be controlled.

“ASPHERICAL COEFFICIENT”: i-th order aspherical coefficient Ai (i is an even number of 4 or larger) in the following aspherical surface equation (1) for the aspherical surfaces S1 through S6:

$$Z = \frac{{x}^{2} \times 1 / R}{1 + \sqrt{1 - ( 1 + K ) \times {x}^{2} \times 1 / {R}^{2}}} + {\sum }_{i = 4 \\ ( even number ) \\} {A}_{i} \times {x}^{i} \qquad ( 1 )$$

where Z is a coordinate in the optical axis direction (the Z-direction in FIG. 2), x is a coordinate in a direction normal to the optical axis (the X-direction in FIG. 2), R is a radius of curvature (inverse of curvature), and K is a conic coefficient.

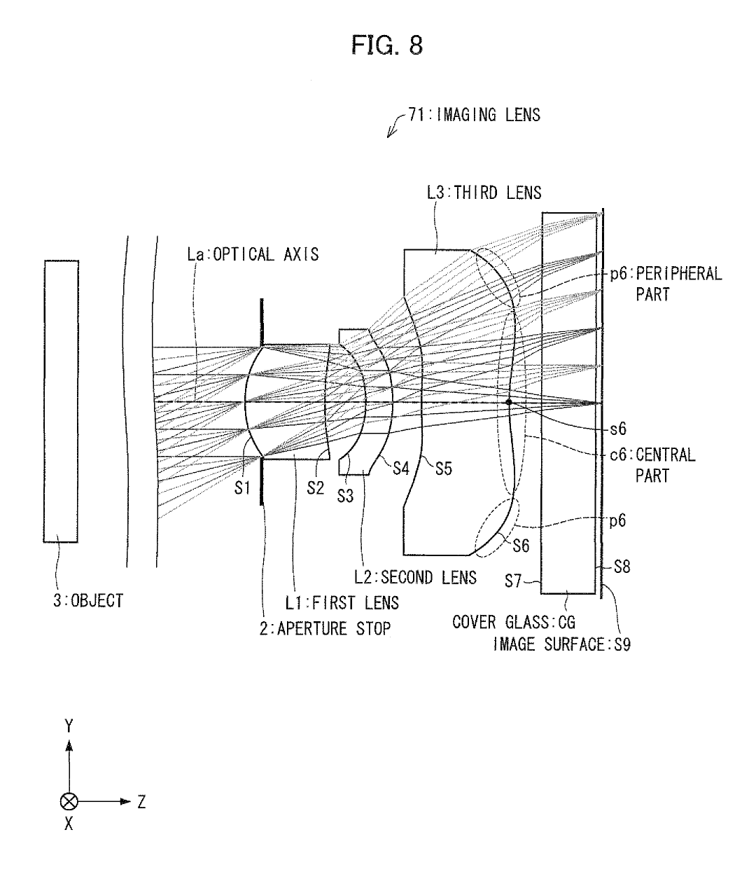

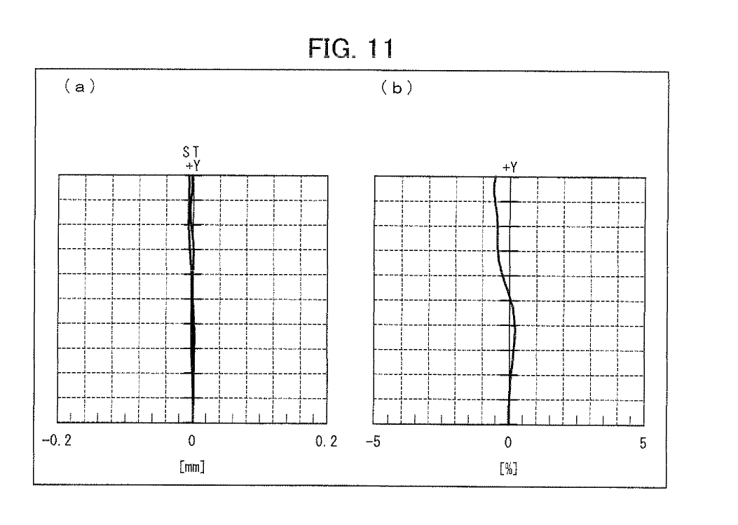

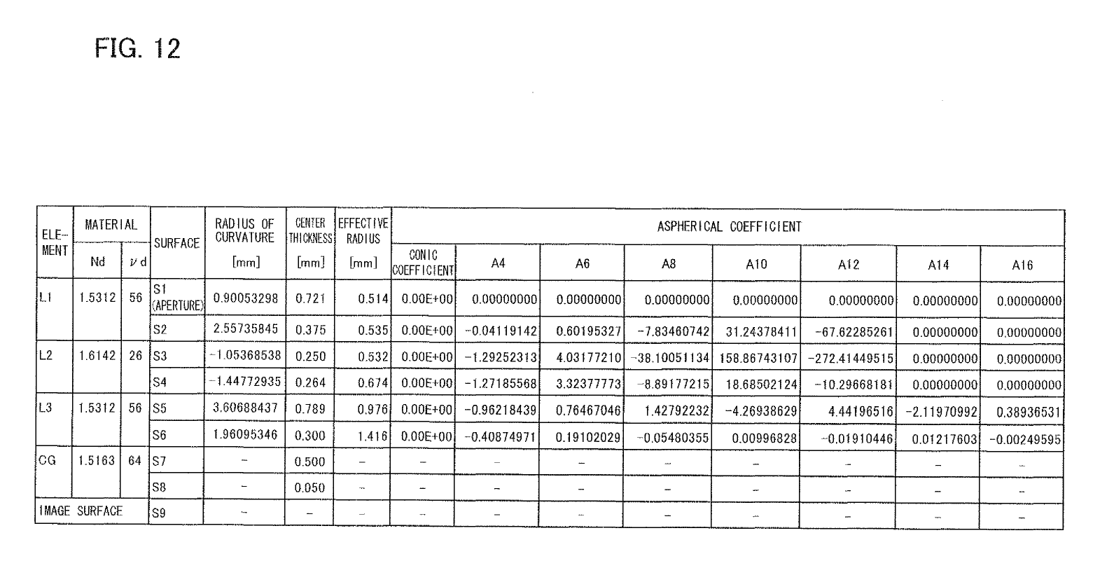

In the table shown in FIG. 7, blocks in which numerical values are different from those (see FIG. 12) of an imaging lens 71 (see FIG. 8) described later are shaded.

As is clear from the table shown in FIG. 7, the region A of the surface S1 of the imaging lens 1 has a radius of curvature (0.89300 mm) that is different from a radius of curvature (0.90000 mm) of the region B. Accordingly, an arrangement in which the regions A and B of the surface S1 of the imaging lens 1 are different in refractive power is achieved.

### COMPARATIVE EXAMPLE

(Optical Properties and Design Data of Imaging Lens 71)

The following description deals with optical properties and design data of the imaging lens 71 to be compared with the imaging lens 1.

As shown in FIG. 8, the imaging lens 71 has an almost similar arrangement to that of the imaging lens 1 (see FIG. 2), but the surface S1 of the first lens L1 has uniform refractive power throughout its entire region.

Note that the optical properties and design data were measured under a similar condition to the imaging lens 1.

(MTF Property of Imaging Lens 71)

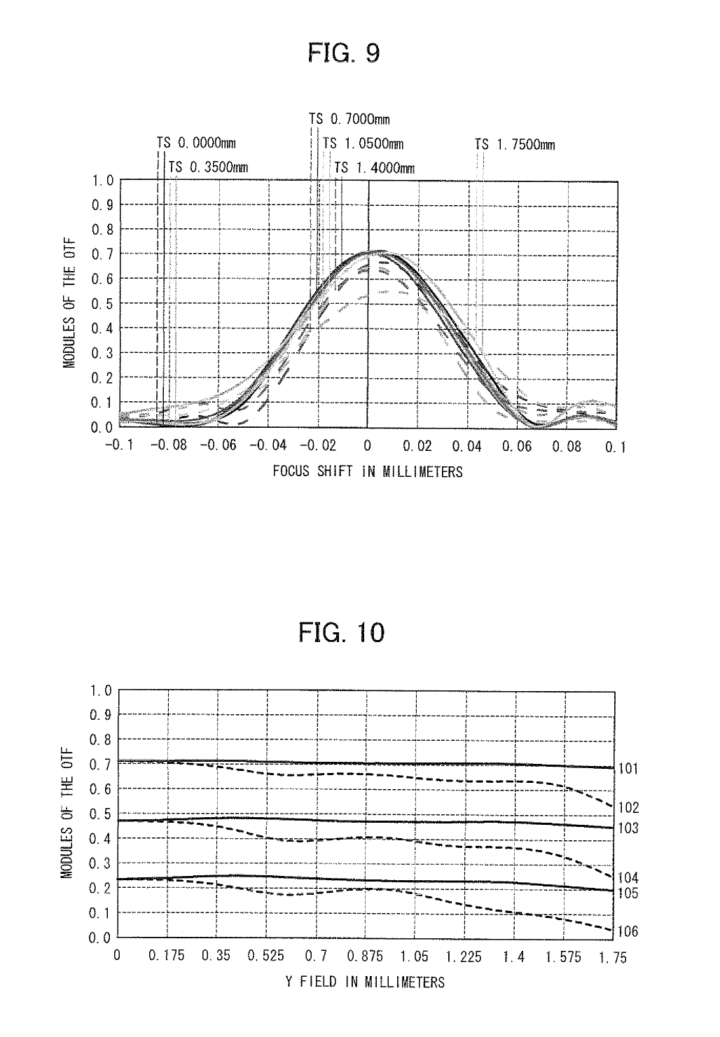

FIG. 9 is a graph showing defocus MTFs in the imaging lens 71, i.e., relationships in the imaging lens 71 between an MTF (unit: none) represented by the vertical axis and a focus shift position (unit: mm) represented by the horizontal axis.

FIG. 10 is a graph showing relationships in the imaging lens 71 between an MTF represented by the vertical axis and an image height (unit: mm) represented by the horizontal axis.

That is, FIGS. 9 and 10 correspond to FIGS. 4 and 5, respectively. There is no difference between FIG. 4 and FIG. 9 and between FIG. 5 and FIG. 10 except for measurement results. Further, the graphs 101 through 106 of FIG. 10 correspond to the graphs 51 through 56 of FIG. 5, respectively.

FIGS. 9 and 10 show that the imaging lens 71 has a slightly better MTF (both of the defocus MTF and MTF-image height property) than the imaging lens 1.

(Aberration Property of Imaging Lens 71)

(a) of FIG. 11 is a graph showing relationship in the imaging lens 71 between the image height (unit: ratio, i.e., image heights h0 to h1.0) represented by the vertical axis and astigmatism (unit: mm) represented by the horizontal axis.

(b) of FIG. 11 is a graph showing relationship in the imaging lens 71 between the image height (unit: ratio, i.e., image heights h0 to h1.0) represented by the vertical axis and distortion (unit: %) represented by the horizontal axis.

(a) and (b) of FIG. 11 show that both of the astigmatism and the distortion in the imaging lens 71 are corrected well to the same extent as the imaging lens 1.

(Design Data of Imaging Lens 71)

FIG. 12 is a table showing design data of the imaging lens 71. The items shown in FIG. 12 have the same definition as those of the design data of FIG. 7.

The surface S1 of the first lens L1 of the imaging lens 71 has a spherical shape, i.e., has a radius of curvature that is uniform throughout its entire region. That is, the imaging lens 71 does not have the arrangement of FIGS. 1 and 3 in which the surface S1 is divided into the regions A and B having different radii of curvature. Accordingly, the radius of curvature of the surface S1 is uniform (0.90053298 mm). Since the imaging lens 71 has a different arrangement from that of the imaging lens 1, the location of the image surface S9 is changed accordingly. According to FIG. 12, the location of the image surface S9 of the imaging lens 71 is changed from that of the imaging lens 1 by changing a distance between the surface S6 of the third lens L3 and the surface S7 of the cover glass CG. The parameters of the imaging lens 71 are identical to those of the imaging lens 1 except for the effective radius.

### Comparison Between Embodiment and Comparative Example

(Design Specifications of Imaging Lens)

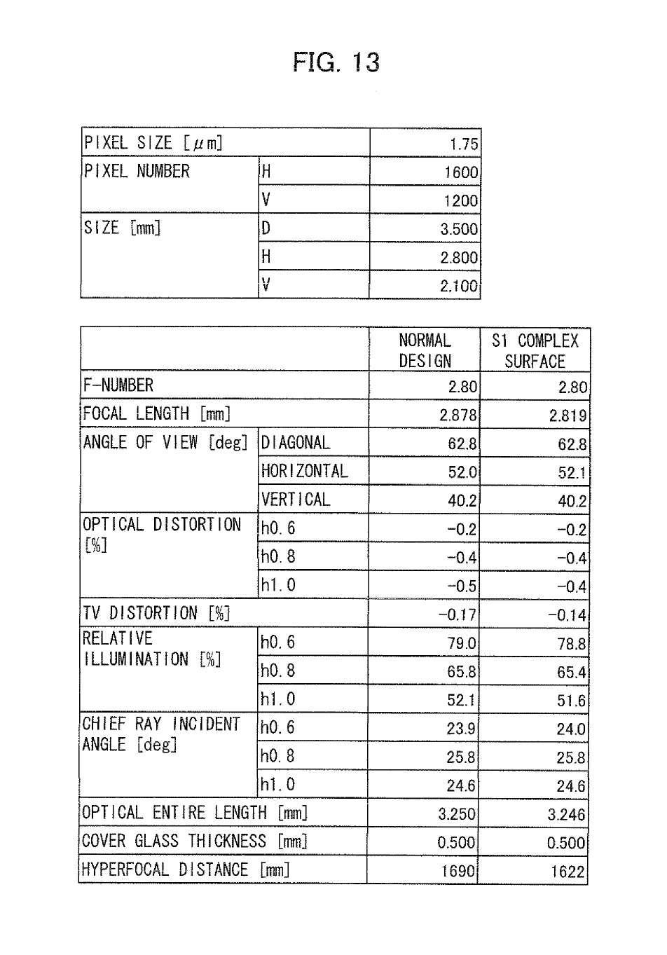

FIG. 13 is a table comparing design specifications of the imaging lens 1 and design specifications of the imaging lens 71 in an imaging module in which a sensor (solid-state image sensing device) is disposed on the image surface S9. The items shown in FIG. 13 are defined as follows.

“PIXEL SIZE”: Size (unit: μm (micrometer)) of a pixel of the sensor (sensor pixel pitch).

“PIXEL NUMBER”: The number of pixels of the sensor which is expressed by two-dimensional (H (horizontal) and V (vertical)) parameters.

“SIZE”: The size (unit: mm) of the sensor which is expressed by three-dimensional (D (diagonal), H (horizontal), and V (vertical)) parameters.

“NORMAL DESIGN”: Specifications of the imaging lens 71.

“S1 COMPLEX SURFACE”: Specifications of the imaging lens 1.

“F-NUMBER”: F-numbers of the imaging lens 1 and the imaging lens 71.

“FOCAL LENGTH”: Focal lengths (unit: mm) of the imaging lens 1 and the imaging lens 71.

“ANGLE OF VIEW”: Angle of view (unit: deg(°)) of the imaging lens 1 and the imaging lens 71, i.e., an angle within which an object can be imaged by the imaging lens 1 and the imaging lens 71. The angle of view is expressed by three-dimensional (diagonal, horizontal, and vertical) parameters.

“OPTICAL DISTORTION”: Specific values (unit: %) of distortion of the imaging lens 1 and the imaging lens 71 at the image height h0.6, image height h0.8, and image height h1.0 among distortion shown in (b) of FIG. 6 and (b) of FIG. 11.

“TV DISTORTION”: TV (Television) distortion (unit: %) of the imaging lens 1 and the imaging lens 71.

“RELATIVE ILLUMINATION”: Relative illumination (unit: %) at the image height h0.6, image height h0.8, and image height h1.0 (ratio of a light amount to a light amount at the image height h0) among relative illumination of the imaging lens 1 and the imaging lens 71.

“CHIEF RAY INCIDENT ANGLE”: CRA (Chief Ray Angle) (unit: deg(°)) of the imaging lens 1 and the imaging lens 71 at the image height h0.6, image height h0.8, and image height h1.0.

“OPTICAL TOTAL LENGTH”: Optical total lengths (unit: mm) of the imaging lens 1 and the imaging lens 71, i.e., distance from a part at which an amount of light is regulated by the aperture stop 2 to the image surface S9. Note that an optical total length of an imaging lens refers to a total dimension, in an optical axis direction, of all constituent members that has a certain effect on optical properties.

“COVER GLASS THICKNESS”: Thickness (unit: mm) of the cover glass CG provided in each of the imaging lens 1 and the imaging lens 71.

“HYPERFOCAL DISTANCE”: Hyperfocal distance (unit: mm) of the imaging lens 1 and the imaging lens 71, i.e., object distance (distance from a lens to a subject) achieved in a case where the farthest point of depth of field is expanded to an infinite distance.

As is clear from FIG. 13, the imaging lens 1 and the imaging lens 71 have the almost same design specifications.

(MTF Property of Imaging Lens in Relation to Object Distance)

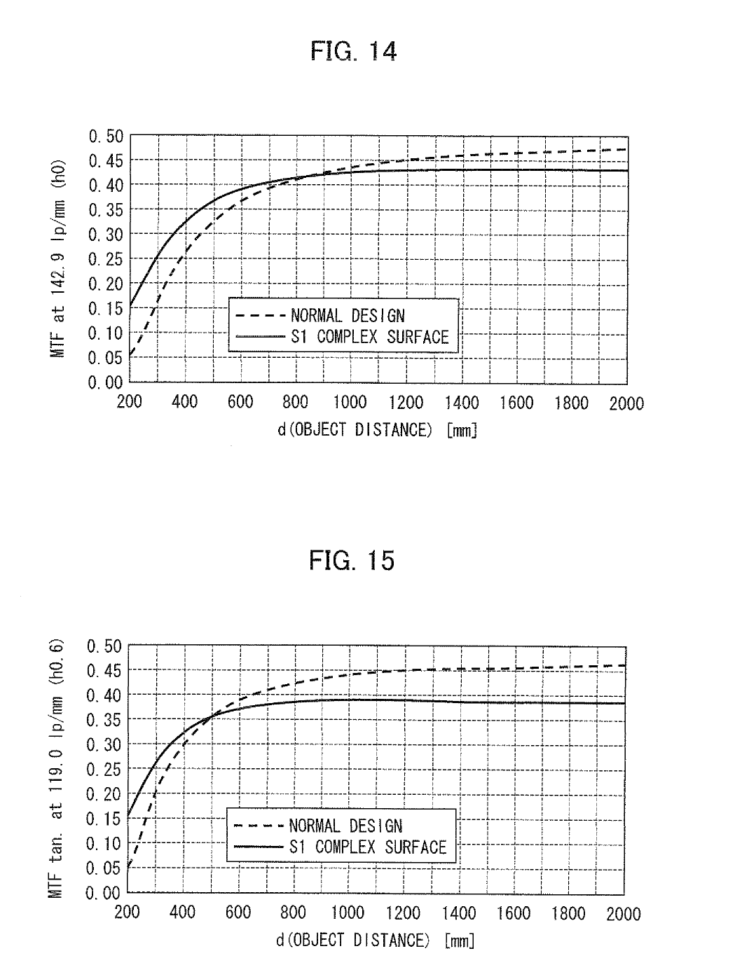

FIG. 14 is a graph showing relationships, in the imaging lens 1 and the imaging lens 71, between an MTF (unit: none) represented by the vertical axis and an object distance (unit: mm) represented by the horizontal axis. FIG. 14 shows the relationships at the image height h0.

FIG. 15 is a graph showing relationships, in the imaging lens 1 and the imaging lens 71, between an MTF (unit: none) represented by the vertical axis and an object distance (unit: mm) represented by the horizontal axis. FIG. 15 shows the relationships at the image height h0.6 in a tangential image surface.

Note that the solid lines in FIGS. 14 and 15 indicate a property of “S1 COMPLEX SURFACE”, i.e., the imaging lens 1, and the broken lines in FIGS. 14 and 15 indicate a property of “NORMAL DESIGN”, i.e., the imaging lens 71.

In the graph of FIG. 14, the spatial frequency is set to 142.9 1 p/mm, which is equivalent to resolution of approximately 600 TV lines. In a case where an MTF threshold value (minimum MTF value considered as being possible for image formation in an imaging lens) is 0.25, the shortest object distance (approximately 300 mm) possible for image formation (resolution) in the imaging lens 1 is shorter than that (approximately 400 mm) in the imaging lens 71 by approximately 100 mm. That is, in a case where the image height is h0, a range of an allowable object distance is larger in the imaging lens 1 than in the imaging lens 71. Moreover, in the imaging lens 1, the MTF, which changes depending on the object distance, changes more gradually than in the imaging lens 71.

In the graph of FIG. 15, the spatial frequency is set to 119.0 1 p/mm, which is equivalent to resolution of approximately 550 TV lines. In a case where an MTF threshold value (minimum MTF value considered as being possible for image formation in an imaging lens) is 0.25, the shortest object distance (approximately 280 mm) possible for image formation (resolution) in the imaging lens 1 is shorter than that (approximately 340 mm) in the imaging lens 71 by approximately 60 mm. That is, also in a case where the image height is h0.6, a range of an allowable object distance is larger in the imaging lens 1 than in the imaging lens 71. Moreover, in the imaging lens 1, the MTF, which changes depending on the object distance, changes more gradually than in the imaging lens 71.

The relationship between the MTF property and the object distance shown in FIGS. 14 and 15 thus reveals that the imaging lens 1, which is arranged such that the surface S1 is constituted by the regions A and B having different refractive power, is larger in range of an allowable object distance than the imaging lens 71 which does not have the arrangement of the imaging lens 1.

(Imaging Module of Present Invention)

An imaging module of the present invention includes the imaging lens 1 and does not include a focusing mechanism for adjusting a focal position of the imaging lens 1. This makes it possible to obtain an imaging module that can produce a similar effect to the first lens L1 of the imaging lens 1.

In a case where an imaging module includes the imaging lens 1 constituted by three lenses, it is possible to produce a compact and inexpensive camera module that has a simple structure and has good resolution. Especially a camera module for use in a mobile apparatus often includes an imaging lens including an aperture stop, a first lens, a second lens (e.g., meniscus lens), and a third lens since such an imaging lens is compact and can achieve high resolution. Accordingly, according to the above imaging module, it is possible to produce an inexpensive camera module that has a simple structure and that does not include a focusing mechanism for adjusting a focal position of an imaging lens.

Further, also in a case where an imaging module includes an imaging lens constituted by two lenses, it is possible to produce a compact and inexpensive camera module that has a simple structure and has good resolution. Especially a camera module for use in a mobile apparatus often includes an imaging lens including two lenses, i.e., an imaging lens including, from an object side to an image surface side, an aperture stop, a first lens having positive refractive power and a second lens having negative refractive power, since such an imaging lens is compact and can achieve high resolution. Accordingly, according to the above imaging module, it is possible to produce an inexpensive camera module that has a simple structure and that does not include a focusing mechanism for adjusting a focal position of an imaging lens.

The imaging module is preferably arranged such that refractive power of the regions A and B is determined so that predetermined resolution (MTF etc.) can be obtained at a determined location of the image surface S9.

This makes it possible to make best use of the advantages of the first lens L1 in the imaging module. That is, in the imaging module, a range of an allowable object distance can be increased on the image surface S9.

Further, it is preferable that the imaging module includes a sensor (solid-state image sensing device) provided on the image surface S9.

The sensor is provided on the image surface S9 of the imaging lens 1. The sensor receives, as an optical signal, an image of the object 3 formed by the imaging lens 1, and then converts the optical signal into an electric signal. The sensor is a known electronic image sensor or the like represented by a solid-state image sensing device constituted by a CCD (Charge Coupled Device) or a CMOS (Complementary Metal Oxide Semiconductor).

The imaging module is an optical system in which a range of an allowable object distance is large. Accordingly, in a case where the imaging module includes the sensor, it is possible to provide a digital camera which does not require a focusing mechanism and which can be manufactured at low cost.

Further, it is preferable that the number of pixels of the sensor is not less than 1.3 mega-pixels. This is because an optical system having the small number of pixels has a short focal length, and can focus on a broad range, and therefore has a large range of an allowable object distance from the beginning. That is, such an optical system having the small number of pixels does not require the arrangement of the first lens L1.

Further, the technique for the imaging module is applicable not only to an imaging module manufactured by a conventional general manufacturing method, but also to an imaging module that can be manufactured by a wafer-level lens process.

The wafer-level lens process is described below. A plurality of first lenses L1 are molded or shaped on an identical surface of an article to be molded such as resin with the use of an array mold for example. Thus, a first lens array including the plurality of lenses L1 is produced. A second lens array including a plurality of second lenses L2 and a third lens array including a plurality of third lenses L3 are produced in a similar way. Further, a sensor array including a plurality of sensors on an identical surface is prepared. Then, the first lens array, the second lens array, the third lens array, and the sensor array, which may be covered with the cover glass CG as necessary, are bonded to each other so that each of the first lenses L1 is disposed face-to-face with a corresponding one of the second lenses L2, a corresponding one of the third lenses L3, and a corresponding one of the sensors. Then, the aperture stops 2 are mounted. The structure thus obtained is divided into plural sets each including an aperture stop 2, a first lens L1, a second lens L2, a third lens L3, and a sensor that face one another. Thus, imaging modules are manufactured. This manufacturing process makes it possible to manufacture a large number of imaging modules at the same time for a short period of time, thereby allowing a reduction in manufacturing cost of an imaging module.

The wafer-level lens process makes it possible to manufacture a large number of imaging modules at the same time for a short period of time, thereby allowing a reduction in manufacturing cost of an imaging module. Especially an imaging module which does not require a mechanism for adjusting a focal position of the imaging lens 1 is suitable for the simplified manufacturing process in which the first lenses L1 are formed so as to be integral with each other, the second lenses L2 are formed so as to be integral with each other, the third lenses L3 are formed so as to be integral with each other, and a plurality of sensors are formed so as to be integral with each other. In contrast, an imaging module which requires the mechanism requires a structure suitable for a manufacturing process in which a plurality of mechanisms for adjusting a focal position of the imaging lens 1 are provided on an identical surface at a wafer level and a structure thus obtained is divided into units each including an imaging module after sensors are provided.

Further, an imaging module manufactured by the wafer level lens process is preferably arranged such that at least one of lenses constituting the imaging lens 1 is made of a thermo-setting resin or a UV-curable resin.

According to the arrangement in which at least one of lenses constituting the imaging lens 1 is made of a thermo-setting resin or a UV-curable resin, it is possible to produce a lens array by molding a plurality of lenses in a resin at production of an imaging module and to reflow the imaging lens 1. Since no care is required for resistance of the lens made of a thermo-setting resin or a UV-curable resin to heat of a driving system of the imaging module, the imaging module is suitable for a reflowable lens.

(Other: Arrangement 1 Preferably Combined with Present Invention)

The imaging module of the present invention may have the following arrangement to be combined with the above arrangement of the imaging module of the present invention. Specifically, the imaging module of the present invention may be arranged to include an imaging lens with expanded depth of field and reduced field curvature and a sensor provided between (i) a location of a best image surface for white light from an object nearer to the sensor than a predetermined location and (ii) a location of a best image surface for white light from an object farther from the sensor than the predetermined location. Note that, in this case, the depth of field is expanded and the field curvature is reduced to the extent that as high resolution (MTF etc.) as possible can be obtained at the location of the sensor.

According to the arrangement, the imaging lens has expended depth of field. This reduces blur of an image of an object which is formed in a wide range of distance from a near point to a far point. Further, the imaging lens has reduced field curvature. This reduces blur of an entire image. In the imaging module including the imaging lens that is sufficiently arranged to reduce blur of an image, it is preferable that the sensor is provided in the above-mentioned location. This allows the imaging module to obtain an image whose blur is reduced on average both in photographing a near-by object and photographing a distant object. As a result, a certain level of good resolution can be achieved.

This imaging module can be arranged to have resolution good enough to satisfy required specifications both in photographing a near-by object and photographing a distant object even if both of the location of the imaging lens and the focal position of the imaging lens are fixed. Accordingly, this imaging module does not require a mechanism for changing a location of a lens or a focal position of the lens in accordance with a location of an object. This simplifies a structure of the imaging module.

The sensor may be arranged to be capable of supplying only information on pixels which is obtained from green monochromatic radiation.

The arrangement allows a two-dimensional matrix code to be read by reading processing based on the information on pixels which is obtained from the green monochromatic radiation.

The sensor may be provided in a location of a best image surface for the green monochromatic radiation from an object which is nearer to the sensor than the predetermined location.

The arrangement allows the sensor to recognize a fine two-dimensional matrix code. As such, it is possible to read a finer two-dimensional matrix code.

The sensor may be arranged such that a pixel pitch is not more than 2.5 μm.

According to the arrangement, it is possible to produce an imaging module which sufficiently utilizes a capability of an image sensor having a large number of pixels.

The imaging lens may be mounted on the sensor via a protecting member for protecting the sensor.

According to the arrangement, a housing (case) for containing the imaging lens can be omitted from the imaging module. This allows a reduction in size, height, and cost of the imaging module.

In a case where the imaging lens has an f-number of not more than 3, it is possible to increase a received light amount. This makes it possible to make an image brighter. Further, it is possible to correct chromatic aberration well. This makes it possible to obtain high resolution.

The imaging lens may be arranged to have expanded depth of field and reduced field curvature, and form an image of an object between (i) a location of a best image surface for white light from an object that is nearer to an image forming location than a predetermined location and (ii) a location of a best image surface for white light from an object that is farther from the image forming location than the predetermined location.

According to the arrangement, the imaging lens has expended depth of field. This reduces blur of an image of an object which is formed in a wide range of distance from a near point to a far point. Further, the imaging lens has reduced field curvature. This reduces blur of an entire image. In the imaging lens that is sufficiently arranged to reduce blur of an image, an image of an object is formed in the above-mentioned location. This allows the imaging lens to obtain an image whose blur is reduced on average both in photographing a near-by object and photographing a distant object. As a result, a certain level of good resolution can be achieved.

This imaging lens can be arranged to have sufficiently good resolution both in photographing a near-by object and photographing a distant object even if both of the location of the imaging lens and the focal position of the imaging lens are fixed. Accordingly, an imaging module including this imaging lens does not require a mechanism for changing a location of a lens or a focal position of the lens in accordance with a location of an object. This simplifies a structure of the imaging module. In other words, this imaging lens is suitably used to produce the imaging module.

A code reading method is a code reading method for reading, with use of the imaging module, a two-dimensional matrix code on a basis of information on pixels that is obtained from green monochromatic radiation, the code reading method including the steps of: finding, on a basis of a pixel pitch obtained from the green monochromatic radiation, values of critical resolving performances of the imaging lens and the sensor so as to set, as a value of a critical resolving performance of the imaging module, a lower one of the values of critical resolving performances; finding a magnification at which an image is formed by the imaging lens, on a basis of (i) a distance between the imaging lens and an object which is nearer to the imaging lens than the predetermined position, (ii) an angle of view of the imaging module, and (iii) an effective image circle diameter of the sensor; and finding a size of a two-dimensional matrix code which the imaging module can read, on a basis of (i) the value of the critical resolving performance of the imaging module and (ii) the magnification.

According to the arrangement, it is possible to increase resolution of the imaging module when a two-dimensional matrix code is read with the use of the imaging module.

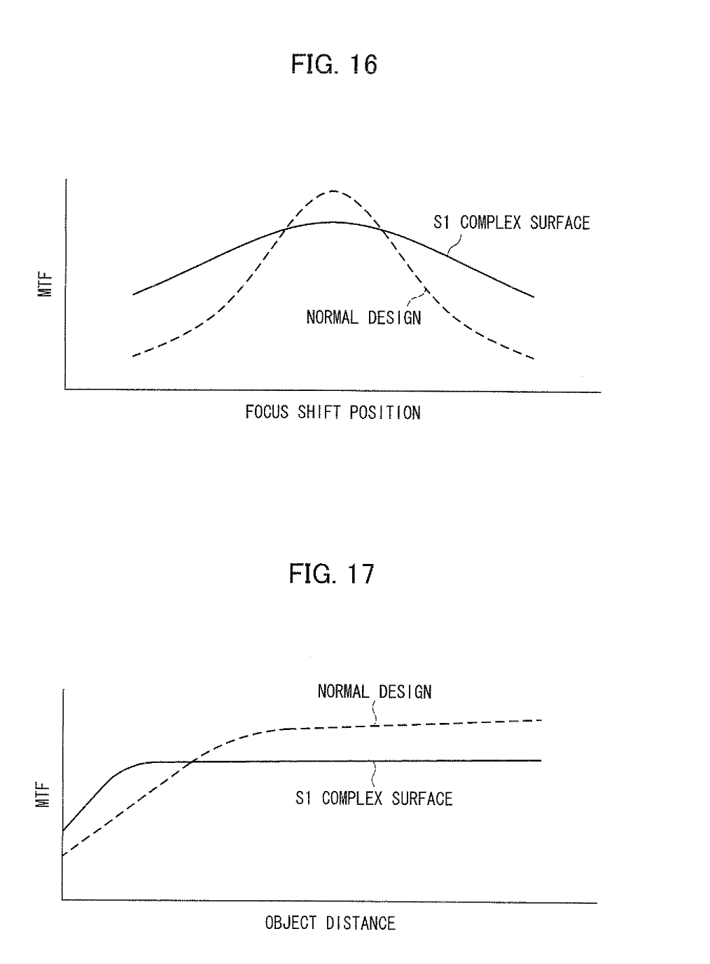

FIG. 16 is a graph showing defocus MTFs, i.e., relationships between an MTF (unit: none) represented by the vertical axis and a focus shift position (unit: mm) represented by the horizontal axis, which graph shows both of (i) a defocus MTF, i.e., a relationship between an MTF and a focus shift position that is achieved in a case where the surface S1 (see FIG. 1) of the first lens L1 of the imaging lens 1 is applied to the imaging module of this section (i.e., S1 complex surface) and (ii) a defocus MTF, i.e., a relationship between an MTF and a focus shift position that is achieved in a case where the surface S1 of the first lens L1 of the imaging lens 1 is not applied to the imaging module of this section (i.e., normal design).

According to the imaging module of this section, a slope of a curve indicative of the defocus MTF is relatively gradual as a whole since the depth of field is expanded. As a result, a good MTF value is obtained in a relatively wide range of the focus shift position. In a case where the imaging lens 1 having the surface S1 (see FIG. 1) is applied to the imaging module, the slope of the curve indicative of the defocus MTF becomes more gradual as a whole. As a result, a good MTF value is obtained in a wider range of the focus shift position.

(Other: Arrangement 2 Preferably Combined with Present Invention)

The imaging module of the present invention may have the following arrangement to be combined with the above arrangement of the imaging module of the present invention. Specifically, the imaging module of the present invention may be arranged to include a rotationally-symmetrical imaging optical system; and an image processing section for carrying out image processing with respect to an image signal generated by the imaging optical system, the imaging optical system including: an imaging lens and a sensor for converting light focused by the imaging lens into an image signal, the imaging lens being arranged such that a location of a best image surface for a sagittal image surface is shifted, in an optical axis direction, from a location of a best image surface for a tangential image surface by a shift amount corresponding to a subject (object) photographable range within which predetermined standard resolution can be obtained, and in a case where one of resolution in a sagittal direction and resolution in a tangential direction is equal to or larger than the standard resolution, the image processing section carrying out, with respect to the image signal converted by the sensor, image processing of increasing the other one to resolution equal to or larger than the standard resolution.

According to the arrangement, both of the resolution in the sagittal direction and the resolution in the tangential direction satisfy the standard resolution as a result of the image processing, as long as any one of the resolution in the sagittal direction and the resolution in the tangential direction satisfies the standard resolution. This allows resolution of an entire image indicated by the image signal to be equal to or larger than the standard resolution.

Accordingly, a resolving performance increases. Since (i) a range in which any one of the resolution in the sagittal direction and the resolution in the tangential direction satisfies the standard resolution becomes a depth of focus and (ii) the location of the best image surface for the sagittal image surface is shifted from the location of the best image surface for the tangential image surface, it is possible to increase the depth of focus. Further, since the depth of focus can be increased in accordance with the shift amount, depth of field can be increased depending on design.

Accordingly, in a case where one of the sagittal image surface and the tangential surface serves as an image forming location for a near-by object, and the other one of the sagittal image surface and the tangential surface serves as an image forming location for a distant object, it is possible to obtain an image having resolution equal to or larger than the predetermined standard resolution in a wide range from photographing of a near-by object to photographing of a distant object even in a case where the imaging lens and the sensor are fixedly disposed.

The imaging module can obtain an image having desired resolution without the use of a focusing mechanism. Since no focusing mechanism is required, it is possible to simplify a structure of the imaging module.

Consequently, it is possible to provide a simple-structured imaging module that has resolution good enough to satisfy required specifications in a wide range from photographing of a near-by object to photographing of a distant object.

The shift amount is preferably determined so as to satisfy the following equation (2):

$$\frac{{f}^{2}}{{Δ}^{′} + {P}_{diff}} < {d}_{near} \\ {P}_{diff} > {Δ}^{′} \times 0.3 \\ f > 1.5 mm \qquad ( 2 )$$

where dnear is a distance between a closest location at which a subject can be photographed at the standard resolution and the imaging lens, f is a focal length, Δ′ is a depth of focus, and Pdiff is the shift amount.

FIG. 17 is a graph showing relationships between an MTF (unit: none) represented by the vertical axis and an object distance (unit: mm) represented by the horizontal axis, in which graph both of (i) relationship achieved in a case where the surface S1 (see FIG. 1) of the first lens L1 of the imaging lens 1 is applied to the imaging module of this section (i.e., S1 complex surface) and (ii) relationship achieved in a case where the surface S1 of the first lens L1 of the imaging lens 1 is not applied to the imaging module of this section (i.e., normal design) are shown.

The graph shown in FIG. 17 exhibits a very similar phenomenon to the graphs shown in FIGS. 14 and 15 in a case where the arrangement including the imaging lens 1 having the surface S1 (see FIG. 1) is applied to the imaging module of this section. That is, a degree of a change in MTF, which depends on a change in object distance, is smaller in the arrangement which includes the imaging lens 1 than the arrangement which does not include the imaging lens 1. Accordingly, a range of an allowable object distance can be increased as in the cases of FIGS. 14 and 15.

Further, the arrangement (see FIG. 17) of the imaging module of this section can be combined with the arrangement (see FIG. 16) of the previous section in which a depth of focus is increased.

The lens element of the present invention is arranged such that the plurality of regions of the at least one lens surface are different from one another in radius of curvature.

According to the arrangement, it is possible to easily produce a lens element having at least one lens surface that is constituted by a plurality of regions having different refractive power.

The lens element of the present invention is arranged such that at least one of the plurality of regions is a surface for diffracting incident light.

According to the arrangement, it is possible to easily produce a lens element having at least one lens surface that is constituted by a plurality of regions having different refractive power.

The imaging lens of the present invention further includes a third lens disposed nearer to the image surface side than the second lens, the second lens having negative refractive power, the third lens having positive refractive power, and a surface of the third lens which surface faces the image surface side having a concave central part and a convex peripheral part surrounding the concave central part.

According to the arrangement, it is possible to produce an imaging lens that is constituted by three lenses (lens elements) and that produces a similar effect to the lens element of the present invention.

The imaging lens of the present invention is arranged such that a surface of the second lens which surface faces the image surface side has a concave central part and a convex peripheral part surrounding the concave central part.

According to the arrangement, it is possible to produce an imaging lens that is constituted by two lenses (lens elements) and that produces a similar effect to the lens element of the present invention.

The imaging lens of the present invention is arranged such that an f-number is less than 3.0.

According to the arrangement, it is possible to obtain a bright image. That is, according to the present invention, it is possible to produce an optical system (i) which includes an imaging lens that can obtain a bright image and (ii) in which a range of an allowable object distance is large. Note that the range of an allowable object distance can be increased by increasing the f-number, but an increase in f-number makes an image dark. According to the present invention, it is possible to produce an optical system that can obtain a bright image and that is large in range of an allowable object distance.

The imaging module of the present invention is arranged such that refractive power of each of the plurality of regions of the lens element is determined so that predetermined resolution is obtained in a predetermined location of an image surface.

According to the arrangement, in the imaging module of the present invention, it is possible to make best use of the advantages of the lens element of the present invention. Specifically, in the imaging module of the present invention, a range of an allowable object distance is increased on an image surface.

The imaging module of the present invention is arranged to further include a solid-state image sensing device disposed on an image surface.

The imaging module of the present invention is an optical system in which a range of an allowable object distance is large. Accordingly, in a case where the imaging module of the present invention includes a solid-state image sensing device, it is possible to produce a digital camera which does not require a focusing mechanism and which can be manufactured at low cost.

The imaging module of the present invention is preferably arranged such that the number of pixels of the solid-state image sensing device is not less than 1.3 mega-pixels. This is because an optical system having the small number of pixels has a short focal length, and can focus on a broad range, and therefore has a large range of an allowable object distance from the beginning. That is, such an optical system having the small number of pixels does not require the arrangement of the present invention.

The imaging module of the present invention is produced by (i) forming a combination constituted by (a) a lens array including, on an identical surface, a plurality of lenses, each of which is a lens closest to the image surface among the lenses constituting the imaging lens and (b) a sensor array including, on an identical surface, a plurality of solid-state image sensing devices, the lens array and the sensor array being bonded to each other so that each of the plurality of lenses faces a corresponding one of the plurality of solid-state image sensing devices and (ii) then dividing the combination thus obtained into plural sets each including a lens and a solid-state image sensing device that face each other.

The imaging module of the present invention is arranged such that the imaging lens includes a plurality of lenses, and the imaging module is produced by (i) forming a combination constituted by (a) a first lens array including, on an identical surface, a plurality of lenses, each of which is one of adjacent lenses constituting the imaging lens and (b) a second lens array including, on an identical surface, a plurality of lenses, each of which is the other one of the adjacent lenses, the first lens array and the second lens array being bonded to each other so that each of the plurality of lenses of the first lens array faces a corresponding one of the plurality of lenses of the second lens array and (ii) then dividing the combination thus obtained into plural sets each including two lenses that face each other.

According to the arrangement, a large number of imaging modules can be produced at the same time for a short period of time. This allows a reduction in cost for manufacturing an imaging module. Especially an imaging module which does not requires a mechanism for adjusting a focal position of an imaging lens is suitable for the simplified manufacturing process for manufacturing an imaging module in which a plurality of lens elements are formed so as to be integral with each other and a plurality of sensors are formed so as to be integral with each other. In contrast, an imaging module which requires the mechanism requires a structure suitable for a manufacturing process in which a plurality of mechanisms for adjusting a focal position of an imaging lens are provided on an identical surface at a wafer level and a structure thus obtained is divided into units each including an imaging module after sensors are provided.

The imaging module of the present invention is arranged such that at least one of the lenses constituting the imaging lens is made of a thermo-setting resin or a UV-curable resin.

According to the arrangement, at least one of the lenses constituting the imaging lens of the present invention is made of a thermo-setting resin or a UV (ultraviolet)-curable resin. This makes it possible to form a lens array by molding a plurality of lenses in a resin at production of an imaging module and to reflow an imaging lens. Since no care is required for resistance of the lens made of a thermo-setting resin or a UV-curable resin to heat of a driving system of the imaging module, the imaging module of the present invention is suitable for a reflowable lens.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to (i) an imaging module that is arranged to have resolution good enough to satisfy required specifications both in photographing a near-by object and in photographing a distant object, (ii) a lens element constituting the imaging module, and (iii) an imaging lens constituting the imaging module.

### REFERENCE SIGNS LIST

1: Imaging lens

2: Aperture stop

3: Object

L1: First lens (lens element)

L2: Second lens

L3: Third lens

A and B: Regions (a plurality of regions having different refractive power)

S1: Surface of the first lens which surface faces an object side (at least one lens surface)

S6: Surface of the third lens which surface faces an image surface side

S9: Image surface

c6: Central part

p6: Peripheral part

1. A lens element having at least one lens surface that is constituted by a plurality of regions having different refractive power so that a range of an allowable object distance is increased.

2. The lens element according to claim 1, wherein the plurality of regions of the at least one lens surface are different from one another in radius of curvature.

3. The lens element according to claim 1, wherein at least one of the plurality of regions is a surface for diffracting incident light.

4. An imaging lens comprising:
an aperture stop;
a first lens having positive refractive power; and
a second lens,
the aperture stop, the first lens, and the second lens being provided in this order from an object side to an image surface side,
the first lens being a lens element having at least one lens surface that is constituted by a plurality of regions having different refractive power so that a range of an allowable object distance is increased, and
a surface of the first lens which surface faces the object side being the at least one lens surface of the lens element.

5. The imaging lens according to claim 4, further comprising a third lens disposed nearer to the image surface side than the second lens,
the second lens having negative refractive power,
the third lens having positive refractive power, and
a surface of the third lens which surface faces the image surface side having a concave central part and a convex peripheral part surrounding the concave central part.

6. The imaging lens according to claim 4, wherein
a surface of the second lens which surface faces the image surface side has a concave central part and a convex peripheral part surrounding the concave central part.

7. The imaging lens according to claim 4, wherein an f-number is less than 3.0.

8. An imaging module comprising an imaging lens,
the imaging lens including:
an aperture stop;
a first lens having positive refractive power; and
a second lens,
the aperture stop, the first lens, and the second lens being provided in this order from an object side to an image surface side,
the first lens being a lens element having at least one lens surface that is constituted by a plurality of regions having different refractive power so that a range of an allowable object distance is increased,
a surface of the first lens which surface faces the object side being the at least one lens surface of the lens element, and
the imaging module including no mechanism for adjusting a focal position of the imaging lens.

9. The imaging module according to claim 8, wherein:
refractive power of each of the plurality of regions of the lens element is determined so that predetermined resolution is obtained in a predetermined location of an image surface.

10. The imaging module according to claim 8, further comprising a solid-state image sensing device disposed on an image surface.

11. The imaging module according to claim 10, wherein the number of pixels of the solid-state image sensing device is not less than 1.3 mega-pixels.

12. The imaging module according to claim 10, produced by (i) forming a combination constituted by (a) a lens array including, on an identical surface, a plurality of lenses, each of which is a lens closest to the image surface among the lenses constituting the imaging lens and (b) a sensor array including, on an identical surface, a plurality of solid-state image sensing devices, the lens array and the sensor array being bonded to each other so that each of the plurality of lenses faces a corresponding one of the plurality of solid-state image sensing devices and (ii) then dividing the combination thus obtained into plural sets each including a lens and a solid-state image sensing device that face each other.

13. The imaging module according to claim 8, wherein:
the imaging lens includes a plurality of lenses, and
the imaging module is produced by (i) forming a combination constituted by (a) a first lens array including, on an identical surface, a plurality of lenses, each of which is one of adjacent lenses constituting the imaging lens and (b) a second lens array including, on an identical surface, a plurality of lenses, each of which is the other one of the adjacent lenses, the first lens array and the second lens array being bonded to each other so that each of the plurality of lenses of the first lens array faces a corresponding one of the plurality of lenses of the second lens array and (ii) then dividing the combination thus obtained into plural sets each including two lenses that face each other.

14. The imaging module according to claim 8, wherein at least one of the lenses constituting the imaging lens is made of a thermo-setting resin or a UV-curable resin.
